(19) United States
(12) Patent Application Publication
(10) Pub. No.: US 2012/0036933 A1
(43) Pub. Date: Feb. 16, 2012

(54) METHOD FOR THE NON-DESTRUCTIVE AND CONTACTLESS CHARACTERIZATION OF A SUBSTANTIALLY SPHERICAL MULTILAYERED STRUCTURE AND RELATED DEVICE

(75) Inventors: Julien Banchet, Lyon (FR); Ahmed Amziane, Argenteuil (FR); Denis Mounier, Le Mans cedex (FR); Jean-Marc Breteau, Le Mans cedex (FR)

(73) Assignees: UNIVERSITE DU MAINE, Le Mans (FR); AREVA NP, Courbevoie (FR)

(21) Appl. No.: 13/141,943

(22) PCT Filed: Dec. 23, 2009
(86) PCT No.: PCT/FR2009/052678

§ 371 Date: Nov. 3, 2011

(30) Foreign Application Priority Data
Dec. 24, 2008 (FR) 08 59075

(51) Int. Cl. G01N 29/12

(52) U.S. Cl. 73/582

(57) ABSTRACT

A method is provided for the non-destructive and contactless characterization of a multilayered structure having a substantially spherical shape and including at least two layers, separated by interfaces. The method includes using a laser for locally heating the structure in a thermoelastic state so that the structure is vibrated in a non-destructive manner, measuring the resonance frequencies of the vibration modes of the structure and deriving at least one characteristic concerning the integrity or the shape or the mechanical behavior of the structure from the resonance frequencies of the structure.

The invention generally relates to methods for non-destructive and contactless characterization of multilayered structures with a spherical or substantially spherical geometry having at least two layers, such as for example nuclear fuel particles, notably for a high temperature reactor. These particles typically include five layers. Subsequently, the term of particle will designate such multilayer structures.

More specifically, the invention according to a first aspect relates to a method for non-destructive and contactless characterization of a multilayered structure with a substantially spherical geometry comprising at least two layers separated by interfaces.

### BACKGROUND OF THE INVENTION

In the case of nuclear fuel particles for a high temperature nuclear reactor, the latter comprise a fissile core coated with layers of dense or porous pyrocarbon, and of ceramic such as silicon carbide or zirconium carbide. The determination of the density, of the thickness, of the Poisson coefficient and of the Young modulus of the core and of each layer making up the fuel particle is essential for qualification of this fuel.

The most currently used method for determining the density is a flotation method. Several control particles are sampled in a batch of particles to be characterized. Each particle is cut out and pieces of each layer are separated in order to carry out density measurements. These pieces are placed in turn in a liquid, the density of which strongly varies depending on temperature. The temperature of the liquid is then varied and it is noted at which temperature the pieces are found “in midwater”. The density of the material making up the piece corresponds to the density of the liquid at said temperature.

This method has the drawback of using toxic liquids. Moreover, this characterization method is slow and causes destruction of the particles to be characterized. Finally, its application proves to be extremely unwieldy since the pieces of each layer have to be separated and identified one by one.

It does not give any information relating to the Poisson coefficient and to the Young modulus. However, it is possible to evaluate these coefficients by methods which have the disadvantage of being destructive (such as for example micro-indentation) and requiring that the measurements be conducted on pieces of each layer, separated and identified one by one.

### SUMMARY OF THE INVENTION

Within this background, the invention is directed to proposing a characterization method which may be applied to particles, which is non-destructive, respectful of the environment, faster to apply, and which allows access to several characteristics in a single measurement.

For this purpose, the invention deals with a non-destructive and contactless characterization method for a multilayered structure with a substantially spherical geometry comprising at least two layers, separated by interfaces, the method comprising the following steps:

by a laser, locally heating the structure under thermoelastic conditions so that the structure is set into vibration in a non-destructive way;

measuring resonance frequencies of the vibration modes of the structure;

inferring from resonance frequencies of the structure, at least one characteristic relating to the integrity, or to the geometry or to the mechanical behavior of the structure.

The method may also include one or more of the characteristics below, considered individually or according to all technically possible combinations:

the measurement of the resonance frequencies is carried out with an optical measurement device,

the optical measurement device comprises an interferometric device,

the presence or absence of a crack in the structure is inferred from the resonance frequencies, the presence of resonance frequencies in at least one predetermined frequency band being characteristic of the presence of a crack in the structure, and the absence of a resonance frequency in said or each predetermined frequency band being characteristic of the absence of any crack in the structure,

at least one sought geometrical or mechanical characteristic of at least one of the layers, selected from density, thickness, Young's modulus and Poisson's coefficient, is inferred from the resonance frequencies of the structure,

said sought geometrical or mechanical characteristic is inferred by an inverse method by:

a) computing theoretical resonance frequencies from respective sets of theoretical or measured values of the geometrical and mechanical characteristics for said or each layer, including first values of said or each sought geometrical or mechanical characteristic, the set of theoretical or measured values comprising for said or each layer the density, the thickness, the Young modulus and the Poisson coefficient;

b) computing the difference between the theoretical resonance frequencies and the measured resonance frequencies;

c) selecting a new value for said or each sought characteristic from the set of corresponding theoretical or measured values and by iterating steps a), b) and c) until the computed difference in step b) is less than a predetermined limit,

the theoretical resonance frequencies are computed in step a) by an analytical vibratory model of the structure,

the inverse method is initialized by computing theoretical initial values for the sought characteristics by inverting a linear vibratory model of the structure, from measured resonance frequencies,

in step c), the new values of said or each sought characteristic are computed by a linear vibratory model of the structure, from first values of said or each sought geometrical or mechanical characteristic considered in step a) and differences between the theoretical resonance frequencies and the measured resonance frequencies, computed in step b),

the structure is a nuclear fuel particle comprising a core and at least two layers surrounding the core,

the nuclear fuel particle comprises, from the interior to the exterior, a fissile material core, a layer of porous pyrocarbon, a first layer of dense pyrocarbon, a ceramic layer and a second layer of dense pyrocarbon, the sought geometric or mechanical characteristics comprising at least two of the characteristics selected from Young's modulus of the porous pyrocarbon layer, Young's modulus of the first dense pyrocarbon layer, Young's modulus of the ceramic layer and the density of the porous pyrocarbon layer,

the laser is an intensity-modulated laser, for example a pulsed laser delivering energy comprised between 1 μJ and 1 mJ per pulse, each pulse having a duration comprised between 0.5 and 50 nanoseconds,

the method comprises the following steps:

measuring the period of the echoes resulting from reflections of elastic waves at the interfaces between the layers;

inferring from said period at least one characteristic relating to the geometry or to the mechanical behavior of the structure,

the propagation velocity of the elastic waves in one of the layers is inferred from the period of the echoes, depending on the thickness of said layer,

Young's modulus of said layer is determined according to the propagation velocity and to the density of said layer.

According to a second aspect, the invention relates to an installation for characterizing a multilayered structure adapted for applying the method above, the installation comprising:

a laser capable of locally heating the structure under thermoelastic conditions so that the structure is set into vibration in a non-destructive way;

a device for measuring resonance frequencies of the vibration modes of the structure;

a computer for inferring from the resonance frequencies of the structure, at least one characteristic relating to the integrity, or to the geometry, or to the mechanical behavior of the structure.

### BRIEF DESCRIPTION OF THE DRAWINGS

Other characteristics and advantages of the invention will become apparent from the detailed description which is given of it below, as an indication and by no means as a limitation, with reference to the appended figures, wherein:

FIG. 1 is a schematic equatorial sectional view illustrating an exemplary structure of a nuclear fuel particle for a high temperature reactor;

FIG. 2 is a schematic view illustrating an installation for applying the characterization method according to invention;

FIG. 3 illustrates an experimental signal collected during the application of the method of the invention for measuring the period of the echoes;

FIG. 4 illustrates an experimental signal collected during the application of the method of invention for measuring the vibratory signal of the particle;

FIG. 5 is a graphic illustration of the vibratory spectrum as inferred from the curve of FIG. 4, showing the resonance frequencies of the excited particle;

FIG. 6 is a step diagram illustrating the main steps of the method of the invention; and,

FIG. 7 is a graphic illustration showing the measured resonance frequencies by means of the installation of FIG. 2, for particles with opening cracks, particles with non-opening cracks and particles which are sound.

### DETAILED DESCRIPTION OF THE DRAWINGS

Opening cracks are cracks opening onto the outer surface of the multilayered structure. Non-opening cracks are cracks, which are not opened at the outer surface of the multilayered structure, the defect then being inside the structure.

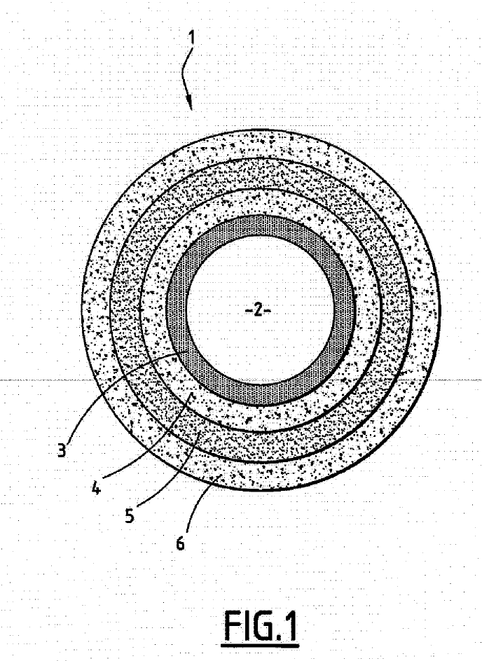

FIG. 1 schematically illustrates a particle 1 of nuclear fuel for a high or very high temperature reactor (HTR/VHTR).

Conventionally, this particle 1 is of a general spherical shape and successively comprises from the interior to exterior;

a fissile material core 2, for example based on UO₂ (these may be other types of fissile material such as UCO, i.e. a mixture of UO₂ and of UC₂ and/or other fissile materials such as compounds based on plutonium, thorium, . . . ),

a porous pyrocarbon layer 3,

a first dense pyrocarbon layer 4,

a layer 5 of silicon carbide (or of another ceramic such as zirconium carbide), and

a second dense pyrocarbon layer 6.

Upon using such a particle, the porous pyrocarbon is used as a reservoir for fission gases, silicon carbide is used as a barrier against diffusion of fission products, and the dense pyrocarbon ensures mechanical strength of the silicon carbide layer.

The core 2 for example has a diameter of about 500 μm, the diameter may vary from 100 μm to 1,000 μm, and the layers 3, 4, 5 and 6, have respective thicknesses of 95, 40, 35 and 40 μm, for example.

It will be seen that the relative dimensions of the core 2 and of the layers 3, 4, 5 and 6 have not been observed in FIG. 1.

These layers, notably the pyrocarbon layers 3, 4, 6, are deposited for example by a chemical vapor deposition method applied in an oven with a fluidized bed.

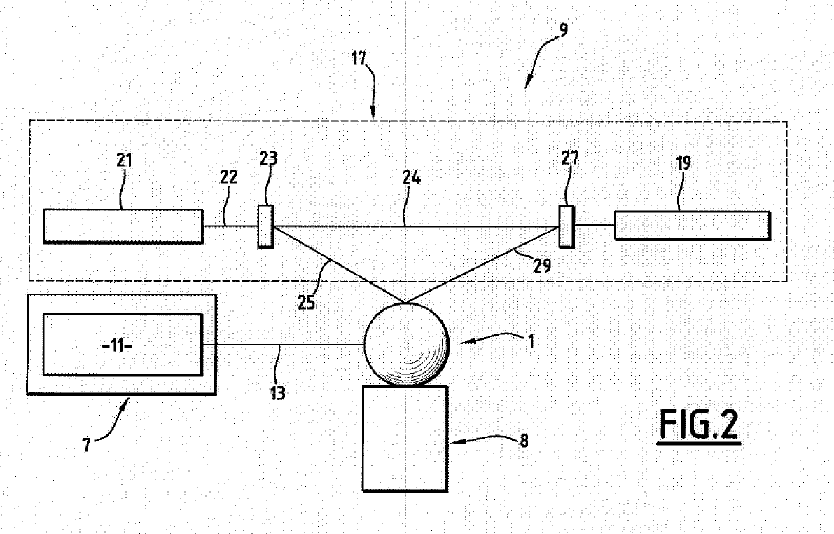

The installation illustrated in FIG. 2 allows:

detection of a crack in the particle illustrated in FIG. 1;

and/or evaluation of one or more geometrical or mechanical characteristics of the core and/or of one of the layers 3 to 6.

Subsequently in the text, “layer” equally means the core or one of the layers surrounding it.

The geometrical or mechanical characteristics which may be evaluated are: the density, the thickness, the Poisson coefficient, the Young modulus.

The installation comprises:

an optical device 7 for excitation of the particle 1;

a support 8 on which the particle is placed;

a measurement device 9 capable of detecting the vibrations of the particle 1 excited by the device 7, and of measuring the resonance frequencies of the particle 1 excited by the device 7;

computing device for detecting a possible crack and/or for evaluating the sought characteristics, from the measured resonance frequencies.

The support 8 is provided in order to maintain the particle 1 in position during the measurement, with a minimum contact area between the particle and the support so as not to affect the vibratory behavior of the particle. Preferably, the contact is point-like or according to a circle of small diameter. Preferably, the support 8 includes means for cooling the particle, so that thermal instabilities do not perturb the measurement.

The excitation device 7 includes an intensity-modulated laser 11. The laser 11 delivers pulses of very short duration, comprised between 0.5 ns and 50 ns and for example pulses having a duration of 0.9 ns.

The laser 11 delivers at each pulse a power comprised between 1 μJ and 1 mJ, for example 5 μJ.

The laser 11 operates at a wavelength comprised between 200 nm and 15,000 nm and having a value of 1047 nm for example.

The device 7 includes a set of optomechanical components allowing delivery and shaping of the beam 13 from the laser 11 right up to the particle 1.

The laser 11 is for example of the Nd:YAG type.

The laser 11 is adjusted so as to locally heat up the particle 1 so that the latter is excited under thermoelastic conditions. The energy delivered by the laser 11 is deposited with a power density of less than 1 GW/cm² in the case of the fuel particle 1 of FIG. 1.

Indeed, it is known that depending on the irradiation power density, the particle 1 may be excited either under thermoelastic conditions or under material ablation conditions. The limiting power density between both conditions depends on the materials making up the particle 1.

In order to be under thermoelastic conditions, i.e. for non-destructive testing, the power density has to be less than the ablation threshold I_{S} (in W/cm²) which depends on the thermophysical data hereafter of the material and which is defined by the relationship:

$${I}_{s} = {( \frac{π K ρ C}{4 {τ}_{L}} )}^{1 / 2} ( {Θ}_{v} - {Θ}_{i} )$$

with K being the heat conductivity; ρ the specific gravity; C the mass heat capacity; Θᵥ the vaporization temperature; Θᵢ the initial temperature; τ_{L} the duration of the laser pulse.

Under thermoelastic conditions, the material making up the particle 1 at least partly absorbs the energy delivered by the laser beam. The delivered power is variable over time because of the modulation of the laser 11. This causes a modulation of the heat expansion of the material making up the particle 1, which in turn causes variation of the mechanical stresses within the material. Consequently, a mechanical vibration occurs within the particle 1. These vibrations will be detected by the measurement device 9.

When the irradiation power density of the laser 11 exceeds a limiting value, the pulses of the laser beam cause detachment of the material making up the particle 1. These are then the ablation conditions.

The measurement device 9 includes an interferometric device 17 and a computer 19. The interferometric device 17 includes a laser 21 producing a beam 22, a splitter 23 dividing the beam 22 into two light waves 24 and 25, and a detector 27. The first light wave 24 is the reference wave which is sent towards the detector 27 either directly or indirectly by means of optomechanical components. The optical phase and the polarization of the reference wave 24 may be modified by one of these optomechanical components.

The second light wave 25 illuminates the particle 1 directly or indirectly by means of optomechanical components. It illuminates the particle 1 either in one point or in an extended area. The wave 25, after having been reflected or diffused by the particle, forms a reflected wave 29 directed towards the detector 27 by means of optomechanical components, where it interferes with the reference wave 24. One of these optomechanical components may modify the optical phase and the polarization of this wave 29.

The vibrations of the surface of the particle 1 modify the optical phase of the wave 25 when the latter is reflected or diffused by the particle 1. This modification of the phase is expressed by a change in the light intensity which is recorded by the detector 27.

The laser 21 of the interferometric device is a continuous laser having a coherence length comprised between 15 cm and 300 m. It has variable power comprised between 5 mW and 5 W, for example 10 mW.

The detector 27 is capable of collecting the vibration of the surface of the particle either in one point or on an extended area of the particle. The collected information is transmitted to the computer 19.

The interferometric device 17 may for example be a stabilized homodyne Michelson interferometer.

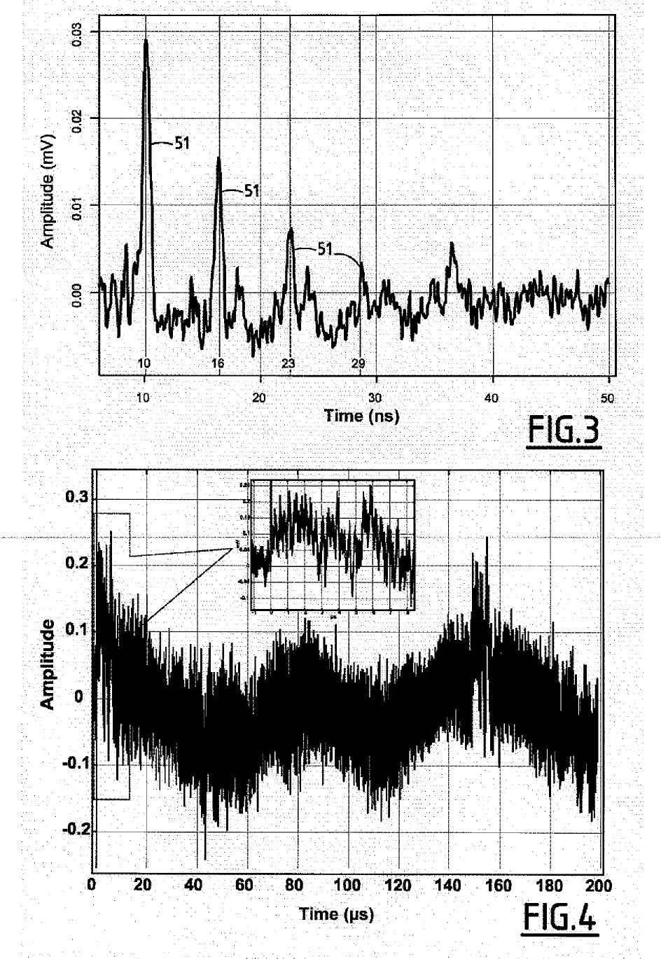

The signal collected by the detector 27 is illustrated in FIG. 3. In this exemplary embodiment, the particle 1 is a particle of nuclear fuel which includes a core and the layers 3 to 5, but not the second dense pyrocarbon layer 6.

The curve of FIG. 3 includes several peaks 51 with large amplitudes, regularly spaced out, and a large number of other peaks with smaller amplitudes.

The curve of FIG. 3 illustrates the vibratory response of the particle to a pulse from the laser 11. The energy deposited by the pulse on the outer surface of the particle is converted by generating elastic waves propagating towards the inside of the latter. Having arrived at the interface between the outermost layer and the underlying layer, a portion is reflected and a portion is transmitted to the underlying layer. The reflected elastic wave, upon arriving at the outer surface of the particle will produce a displacement of the surface which appears as a peak in FIG. 3, as well as a reflection of a portion of the wave towards the inside of the layer. These elastic waves will thus accomplish several round trips in the outermost layer of the particle, generating echoes. Every time the elastic waves arrive at the outer surface of the particle, the displacement of the surface which it produces, is detected. Every time the elastic waves arrive at the interface with the underlying layer, a portion of the energy of the wave is transmitted to this underlying layer.

The same phenomenon is produced again in the underlying layer and in each of the other layers of the particle.

Thus on the curve of FIG. 3, a large number of peaks are detected. The four clearly marked peaks 51 correspond to the elastic waves detected after one round trip of the elastic wave in the outermost layer of the particle, two round trips of the elastic wave in said outermost layer of the particle, and three round trips of the elastic wave in the outermost layer of the particle and four round trips of the elastic wave in the outermost layer of the particle respectively.

The period separating the peaks 51 from each other therefore corresponds to the duration during which the elastic wave covers twice the thickness of the outermost layer of the particle. The propagation velocity of the elastic wave in the outermost layer of the particle is inferred from this duration further called period of the echoes, if the thickness of the outermost layer is moreover known. From this velocity, Young's modulus of the relevant layer may be inferred if its density is known or conversely its density if the Young modulus is known. If the velocity of the elastic wave is known, then it is possible to determine the thickness of this layer. The thicknesses and the densities may be known by means of a radiography method as the one described in the patent application of the applicant having the file number FR0606950.

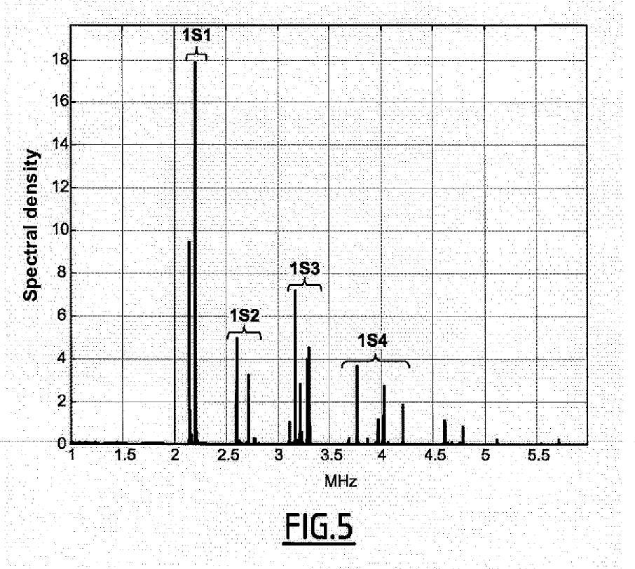

The computer 19, from the time signal detected by the detector 27 (FIG. 4) may compute the spectrum of the resonance frequencies of the vibration modes of the particle 1. This spectrum is illustrated in FIG. 5, and corresponds to the signal of FIG. 4. It is obtained by computing the fast Fourier transform of the digitized time signal of FIG. 4, performed by the computer 19.

Each group of frequencies of the spectrum of FIG. 5 corresponds to resonance frequencies of a vibration mode of the particle 1, as measured experimentally.

Indeed, a perfectly spherical particle has spheroidal vibration modes noted as nSL, where L is an integer called an orbital number and N is another integer designating the order of occurrence of the spheroidal modes SL. The modes of type nSL have a resonance frequency which is 2L+1 fold degenerate, the mode of type nS2 having for example a resonance frequency which is degenerate (2×2)+1=5 fold. As these particles have substantially spherical geometry (sphericity defects), group theory provides lifting of degeneracy of the resonance frequencies of a vibration mode of the nSL type. Therefore, these resonance frequencies may be distinct over an interval, as shown in FIG. 5. The resonance frequencies of four vibration modes 1S1 to 1S4 are noted as 1S1 to 1S4 in FIG. 5.

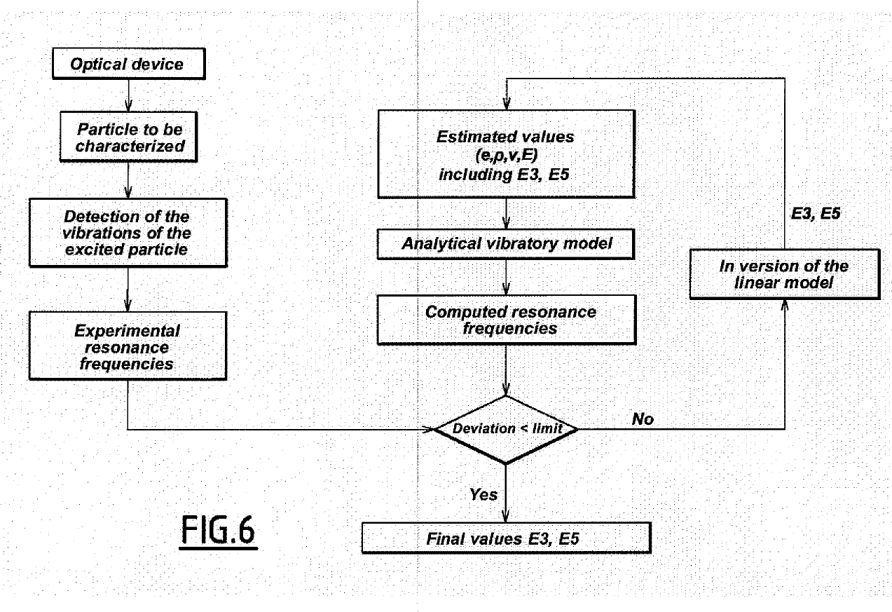

The computer 19 will then consider several vibration modes of the particle 1 and will determine by computation, from the resonance frequencies measured experimentally for the relevant vibration modes, one or more geometrical or mechanical characteristics of the particle, according to the procedure illustrated in FIG. 6 (resolution of the inverse problem).

These characteristics are selected from the thickness, the density, the Young modulus and the Poisson coefficient of each of the layers which make up the particle 1, for example of the core 2 and/or of each of the layers 3 to 6 for the particle of FIG. 1. For a particle with N layers, the characteristics are selected from 4N possibilities.

For the nuclear fuel particle of FIG. 1, the computer will consider certain vibration modes, such as for example the modes 1S1 to 1S4. It will determine from the 20 possible characteristics, for example, Young's moduli E₃ and E₅ of the porous pyrocarbon layer 3 and of the ceramic layer 5.

To do this, the computer 19 will consider for each relevant vibration mode nSL, a so-called experimental resonance frequency. This frequency may for example be selected in the spread interval of the resonance frequencies corresponding to the lifting of degeneracy of the nSL mode. The Monte Carlo method is used for randomly drawing this experimental frequency in a spread interval of the resonance frequencies corresponding to the lifting of degeneracy of the nSL mode. This frequency is retained if it allows convergence of the computing method for the characteristics to be determined The Monte Carlo method also allows evaluation of the uncertainties on the sought characteristics. The experimental frequencies selected for the different relevant vibration modes make up the vector of the experimental frequencies.

The computer 19 then computes, from estimated values of the characteristics of the layers of the particle 1, for example of the core 2 and of the four layers 3 to 6 of the particle of FIG. 1, resonance frequencies computed for the relevant vibration modes.

The computer 19 starts with the estimated values for the thickness, the density, the Poisson coefficient and Young modulus of each of the layers making up the particle 1, i.e. for example in the case of nuclear fuel, a total of 20 values. In particular in this case, the computer 19 for Young's moduli of layers 3 and 5, the determination of which is sought, considers first values obtained from experimental resonance frequencies, as described later on. The other estimated values are realistic values, having been measured or estimated by computation for particles of nuclear fuels with structures close to the one to be characterized.

The most currently used method for directly computing the vibration modes of multilayered objects is the use of simulation software packages by finite elements. This method which has the advantage of simulating objects with geometries close to reality (having defects) has a major drawback which is the computing time which excludes them from real-time characterization in industrial control.

In the invention, on the contrary, the resonance frequencies of the vibration modes are computed by means of an analytical vibratory model of the particles.

With this analytical vibratory model, it is possible to solve the equation of elastic waves in the case of a multilayered structure with spherical symmetry consisting of N domains and comprising a spherical core and N−1 layers, separated by N−1 spherical interfaces, the N domains are considered as being continuous, elastic, isotropic and homogeneous media. Each numbered (n) domain is characterized by its Young's modulus Eₙ its thickness epₙ, its specific gravity ρₙ and as well as its Poisson coefficient vₙ. It is assumed that adhesion is perfect between two adjacent domains. The external layer (n=N) has its outer surface free, forming an interface with the external medium. For example for nuclear fuel particles N=5.

The physical parameters required for solving the problem are the specific gravity ρₙ, the longitudinal velocity c_{L,n} and transverse velocity c_{T,n} of the elastic waves in the different domains which make up the particle (with n=1, 2, . . . , N).

The expression of both of these velocities as a function of the mechanical characteristics of each layer is:

$$\{ \begin{matrix}{c}_{L , n} = \sqrt{\frac{{E}_{n} ( 1 - {v}_{n} )}{{ρ}_{n} ( 1 + {v}_{n} ) ( 1 - 2 {v}_{n} )}} \\ {c}_{T , n} = \sqrt{\frac{{E}_{n}}{2 {ρ}_{n} ( 1 + {v}_{n} )}}\end{matrix}$$

The equation of propagation of elastic waves (also called the equation of motion) in each layer n is:

$$\frac{{\partial }^{2} {\vec{u}}_{n}}{\partial {t}^{2}} = ( {c}_{L , n}^{2} - {c}_{T , n}^{2} ) \vec{∇} ( \vec{∇} \cdot {\vec{u}}_{n} ) + {c}_{T , n}^{2} Δ {\vec{u}}_{n}$$

Wherein \vec{u}ₙ(\vec{r},t) represents the displacement field in the domain n.

In a domain n, the displacement field \vec{u}ₙ which solves the wave equation for objects of spherical symmetry (r,θ,φ) is expressed as a function of a scalar potential ψ_{1,n} and of vector potentials \vec{ψ}_{2,n} et \vec{ψ}_{3,n} such as:

\vec{u}(\vec{r},t)=\vec{∇}ψ_{1,n}+\vec{∇} [symbol] (\vec{∇} [symbol] \vec{ψ}_{2,n})+\vec{∇} [symbol] \vec{ψ}_{3,n}

The vector potentials are radial, being expressed as \vec{ψ}_{2,n}=rψ_{2,n}\vec{e}ᵣ and \vec{ψ}_{3,n}=rψ_{3,n}\vec{e}ᵣ with \vec{e}ᵣ the unit vector along the radial direction.

The potentials ψ_{j,n} verify d'Alembert's equation with different velocities

$$\frac{{\partial }^{2} {Ψ}_{j , n}}{\partial {t}^{2}} - {c}_{j , n}^{2} {∇}^{2} {Ψ}_{j , n} = 0$$

with j=1, 2, 3.

The expression of the velocities is expressed by

$${c}_{j , n} = \{ \begin{matrix}{c}_{L , n} si j = 1 \\ {c}_{T , n} si j = 2 , 3\end{matrix}$$

A particular solution of d'Alembert's equation for spherical geometry in each domain is of the form (in spherical coordinates) for a sinusoidal vibration of angular frequency ω, written as:

ψ_{j,n}(r,θ,φ,t)=[A_{j,n}^{L,m}j_{L}(k_{j,n}r)+B_{j,n}^{L,m}n_{L}(k_{j,n}r)]Y_{L}^{m}(θ,φ)×exp(−iωt)

wherein ω=k_{j,n}×c_{j,n} is the angular velocity Y_{L}^{m}(θ,φ)=Y_{L}^{m,s}(θ,φ) is the function of spherical harmonics of harmonic degree L≧0 and of azimuthal order m (−L≦m≦L). A_{j,n}^{L,m} and B_{j,n}^{L,m} are constants.

The angular portion Y_{L}^{m,c}(θ,φ) corresponds to the real part of non-normalized spherical harmonics defined by:

Y_{L}^{m,c}(θ,φ)=Re[Y_{L}^{m}(θ,φ)]=Re[P_{L}^{|m|}(cos θ)×exp(imφ)]=P_{L}^{|m|}(cos θ)×cos(mφ)

The angular portion Y_{L}^{m,s}(θ,φ) corresponds to the imaginary part of non-normalized spherical harmonics defined by:

Y_{L}^{m,s}(θ,φ)=Im[Y_{L}^{m}(θ,φ)]=Im[P_{L}^{|m|}(cos θ)×exp(imφ)]=P_{L}^{|m|}(cos θ)×sin(mφ)

The radial portion is expressed from spherical Bessel functions of the first kind

$${j}_{L} ( x ) = {{x}^{L} ( - \frac{1}{x} \frac{d}{d x} )}^{L} ( \frac{sin x}{x} )$$

and of the second kind

$${n}_{L} ( x ) = {{x}^{L} ( - \frac{1}{x} \frac{d}{d x} )}^{L} ( - \frac{cos x}{x} )$$

The 2L+1 fold degeneracy of the resonance frequency of the nSL mode gives the possibility of only considering the mode corresponding to m=0 for computing the resonance frequency. The modes m=0 (an axisymmetrical mode) do not depend on φ like:

ψ_{j,n}(r,θ,t)=[A_{j,n}^{L,0}j_{L}(k_{j,n}r)+B_{j,n}^{L,0}n_{L}(k_{j,n}r)]Y_{L}^{0,c}(θ)×cos(ωt)

because Y_{L}^{0,s}(θ,φ)=P_{L}^{|0|}(cos θ)×sin(0×φ)=0.

The solution in the central domain (n=1), corresponding to the core should be limited in its centre whence B_{j,n}^{L,0}=0 since n_{L}(0)=∞ is of the following form:

ψ_{j,n}(r,θt)=A_{j,n}^{L,m}j_{L}(k_{j,n}r)Y_{L}^{m,c}(θ)×cos(ωt)

In order to find the vibration eigenmodes, we should consider boundary conditions at the interfaces and on the free surface: therefore, the wave equation should be solved inside the multilayered sphere, meeting the continuity conditions of displacement and stresses at the interfaces (perfect adhesion), except for the free surface, where the stress is cancelled.

Given the spherical symmetry of the object, the normal at any point of the interface is in a radial direction i.e. along \vec{n}=(nᵣ,n_{θ},n_{φ})=(1,0,0). The components of the stress in spherical coordinates are calculated with:

$$( \begin{matrix}{σ}_{rr} & {σ}_{r θ} & {σ}_{r ϕ} \\ {σ}_{r θ} & {σ}_{θ θ} & {σ}_{θ ϕ} \\ {σ}_{r ϕ} & {σ}_{θ ϕ} & {σ}_{ϕ ϕ}\end{matrix} ) ( \begin{matrix}1 \\ 0 \\ 0\end{matrix} ) = ( \begin{matrix}{σ}_{rr} \\ {σ}_{r θ} \\ {σ}_{r ϕ}\end{matrix} )$$

The displacement components are:

$$\vec{u} = ( \begin{matrix}{u}_{r} \\ {u}_{θ} \\ {u}_{ϕ}\end{matrix} )$$

The sphere comprises N domains and therefore N−1 interfaces.

At the interfaces and at the core (domain 1)

$$\{ \begin{matrix}{\vec{u}}_{i} ( {R}_{i} ) = {\vec{u}}_{i + 1} ( {R}_{i} ) \\ {σ}_{{rr}_{{r θ}_{r ϕ}}}^{i} ( {R}_{i} ) = {σ}_{{rr}_{{r θ}_{r ϕ}}}^{i + 1} ( {R}_{i} )\end{matrix}$$

with i=1, . . . , N−1 being the number of the layer and Rᵢ its outer radius.

At the free surface

$${σ}_{{rr}_{{r θ}_{r ϕ}}}^{N} ( {R}_{N} ) = 0$$

The expression of the boundary conditions leads to an eigenvalue equation. Solving the eigenvalue equation gives the eigenfrequency of each mode.

With the analytical vibratory model it is possible to determine for the relevant vibration modes, the vector of the computed resonance frequencies F_{calc}, corresponding to the vector of the experimental resonance frequency Fₑₓₚ. For example in the case of the nuclear fuel particle of FIG. 1, at least four vibration modes may be identified in FIG. 5, and the vectors of the experimental and computed frequencies each have four components.

For solving the inverse problem, the computer 19 evaluates whether the quadratic distance between the experimental resonance frequencies and the computed resonance frequencies is less than a predetermined limit L. For this, the computer uses the following formula:

∥Fₑₓₚ−F_{calc}∥²<L

wherein L is the predetermined limit, ∥ ∥ designates the Euclidean norm of a vector. Both frequency vectors have the same number of components which is the number of relevant vibration modes.

If the quadratic distance is less than L, then the computer considers that the first values of the sought characteristics (for example Young's moduli E3 and E5), used for evaluating the computed resonance frequencies, are satisfactory and retains them as final values.

On the contrary, if the quadratic distance is greater than the limit L, the computer 19 performs an additional iteration.

For this purpose, the computer 19 generates new values of the sought characteristics (for example Young's moduli E3 and E5). These new values of the characteristics are generated by means of standard error minimization routines which exist in different computing software packages.

These standard routines generally require several tens of iterations which requires excessive computing time.

The invention uses a linear function which computes in an approximate way the resonance frequencies and which will subsequently be called a linear vibratory model.

This linear vibratory model allows rapid computation of the resonance frequencies of the particle for the relevant vibration modes.

In this model, the vector F of the resonance frequencies is written as a sum of a linear function F₀+S·X and of an error vector E i.e. F=F₀+S·X+E,

with F=(fᵢ)_{1=1, . . . , m}, a vector with m components of resonance frequencies of the vibration modes obtained experimentally or obtained with the analytical vibration model (target frequencies); F₀ is a constant vector with m components; X=(x_{α})_{a=1, . . . , n} is a vector with n components of the sought characteristics; S is the sensitivity matrix of dimensions n×m; E is an error vector with m components.

This formalization allows acceleration of the convergence of the quadratic deviation minimization function.

The use of the least squares method (multilinear regression) on the relationship Fₑₓₚ=F₀+S·X+E leads to the first values (estimations) of the sought characteristics X₁.

X₁=(^{t}S·S)⁻¹·^{t}S·(Fₑₓₚ−F₀)

wherein Fₑₓₚ corresponds to the vector of the experimentally determined resonance frequencies.

From the value of X₁, the vector of the resonance frequencies is computed by means of the analytical vibratory model. These computed frequencies F₁ are expressed in the following way by means of the linear model:

F₁=F₀+S·X₁+E₁

The deviation between the experimental frequencies and the computed frequencies is expressed in the following way:

(Fₑₓₚ−F₁)=S·(X−X₁)+(E−E₁)

At each iteration, the error vector E′₁=E−E₁ decreases.

The second estimation of the sought characteristics is computed with

X₂=X₁+ΔX=X₁+(^{t}S·S)⁻¹·^{t}S·(Fₑₓₚ−F₁)

At each estimation or iteration, the deviation between the experimental and computed frequencies decreases.

In the same way, the value of the vector X considered at iteration i+1 (Xᵢ₊₁) is inferred from the value of the vector X used at iteration i (Xᵢ) by using the following equation (method of least squares):

Xᵢ₊₁=Xᵢ+(^{t}S·S)⁻¹·^{t}S·(Fₑₓₚ−Fᵢ)

wherein Fᵢ is a vector with m components corresponding to the resonance frequencies obtained with the analytical vibratory model starting from the characteristics Xᵢ.

This recurrence relationship leads to two convergent series: one convergent series Xᵢ converging towards the limit X_{calc} of the sought characteristics, and one convergent series Fᵢ of the frequencies converging towards a limit F_{calc} such that ∥Fₑₓₚ−F_{calc}∥²<L. The values forming X_{calc} are then retained by the computer as final values.

In the example of the nuclear fuel particle of FIG. 3, m has the value four (number of experimentally identified eigenmodes) and n has the value two (number of characteristics to be sought).

The computer 19 carries out several iterations, by considering at each iteration new values of the two sought Young moduli E₃ and E₅, estimated by means of the inversion of the linear model, until the quadratic deviation between the computed frequencies and the experimental frequencies is less than the predetermined limit.

In practice, consideration of four experimental resonance frequencies is sufficient for determining at least two characteristics from the twenty characteristics mentioned above.

If five experimental resonance frequencies are considered, it is possible to determine at least three or four of the twenty characteristics.

If an even larger number of resonance frequencies is considered, it is possible to determine more than four of the twenty characteristics.

In order to determine whether the particle 1 includes cracks, the computer 19 considers the spectrum of the resonance frequencies of the particle 1, and determines whether it includes resonance frequencies in certain predetermined frequency intervals.

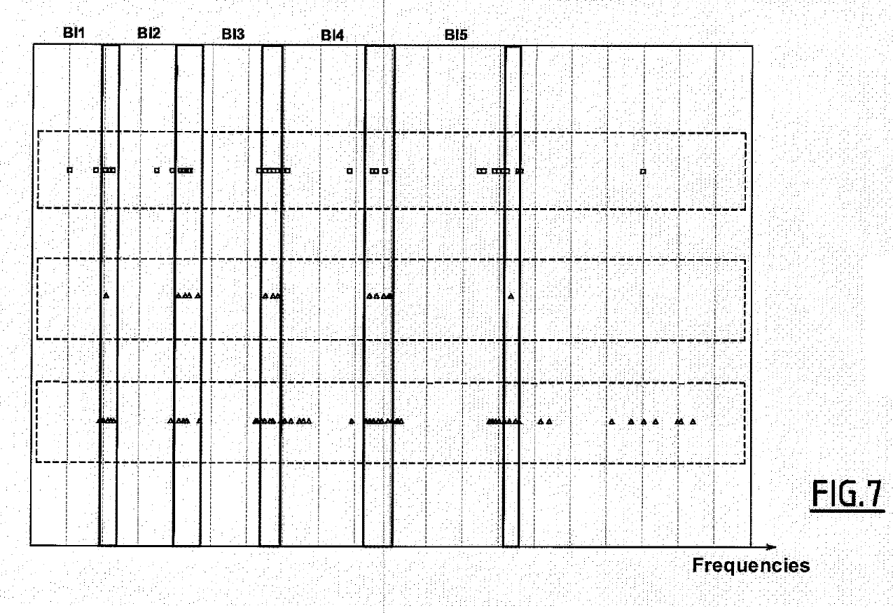

Experimental results corresponding to measurements carried out on different types of particles are gathered in FIG. 7. Each horizontal line corresponds to the spectrum of a particle. These spectra were obtained with an installation like the one illustrated in FIG. 2. In each line, the symbols (circle, cross, plus sign, etc.) are placed at each of the main resonance frequencies of the vibration modes, as measured experimentally.

The upper line corresponds to a particle having a crack opening out onto the outer surface of the particle.

The intermediate line corresponds to a bead which is sound, i.e. not having any cracks.

The line at the bottom corresponds to a particle having a non-opening defect, i.e. a crack which is not open at the outer surface of the particle.

Moreover, frequency ranges in which resonance frequencies of sound beads are found, are materialized by vertically elongated rectangles. Between these frequency ranges are found other ranges referenced as BI1 to BI5 (forbidden band) in FIG. 7, in which a resonance frequency for particles which are sound, is never found.

Thus, in order to determine whether the particle includes cracks or not, the computer determines whether some of the resonance frequencies of the experimentally measured vibration modes for the particle are found in one of the intervals BI1 to BI5. The intervals BI1 to BI5 are predetermined intervals, depending on the type of beads, on the nature of the layers, on the thickness of the layers, etc. These intervals are experimentally determined, by considering a large number of particles including defects and also considering a large number of sound particles.

The method described above is not limited to the detection of opening or non-opening cracks in the particle 1. According to this same principle, it is possible to detect decohesions between layers, abnormal porosities in certain layers, sphericity flaws.

By decohesion is meant areas where two contiguous layers do not have proper adhesion to each other at their mutual interface. By porosity is meant an area of a layer where the material is abnormally porous because of the existence of micro-cavities within the material.

The method described above has multiple advantages.

By locally heating the multilayered structure to be characterized under thermoelastic conditions, by means of a laser and by inferring at least one characteristic related to the integrity or to the geometry or to the mechanical behavior of the structure from the resonance frequencies of the vibration modes of the structure, it is possible to characterize this contactless structure, in a non-destructive, rapid way. With the method it is possible to access certain characteristics such as Young's modulus or the density of one or more of the layers of the structure or of the core, which is extremely difficult with other methods.

The presence of cracks in the structure may be detected in a simple and rapid way, by seeking whether the vibratory spectrum of the particle includes resonance frequencies in one or more predetermined frequency bands. With the method it is possible to detect both opening and non-opening cracks. This method is simple, rapid, reliable and contactless.

The use of an analytical vibratory model for calculating resonance frequencies of a particle contributes to reducing the required computing time for determining the sought characteristics of the particle by the method of least squares. Indeed, computing the resonance frequencies of the particle with such an analytical model is much faster than computing said resonance frequencies with a finite element model.

Also, by using the linear vibratory model described above for determining the new values to be taken into account at the following iteration, it is possible to considerably shorten the computing time and accelerate convergence.

The method may also be used for determining from the period of the echoes resulting from the reflections of elastic waves at the interfaces between the layers, the velocity of elastic waves in at least one of the layers and/or Young's modulus of said layer.

The method described above may have multiple alternatives.

In the case of a nuclear fuel particle, the number of geometrical or mechanical characteristics to be sought may be two, three or more than three depending on the number of relevant experimental resonance frequencies. The number of experimental resonance frequencies which may be used depends on the quality of the signal detected by the interferometric device. Thus, by considering five resonance frequencies, it is possible to determine with good accuracy the combinations of four characteristics from the thicknesses, the Young moduli, the densities and the Poisson coefficients.

It is possible not to use any linear vibratory model for determining the values of the sought characteristics to be taken into account during the following iteration. In this case, standard routines (Nelder-Mead, quasi-Newton, conjugate gradients, etc.) for minimization which exist in most computing software packages may perform this operation.

Also, it is possible to use a model different from the analytical vibratory model described above for determining the resonance frequencies such as finite element models used in most simulation software packages.

If the number of experimentally obtained resonance frequencies is less than the number of parameters of the object as soon as the number of layers N 2, the resolution of the inverse problem becomes subdetermined. In order that the inverse problem admits a solution, the parameters which may be determined in a robust way and those which may be known a priori, have to be selected. This selection depends on the structure of the multilayered object.

In this context, the invention proposes a solution to the inverse problem which uses the sensitivity (or effect) of each parameter on each of the resonance frequencies.

$${S}_{i α} = \frac{\partial {f}_{i}}{\partial {x}_{α}}$$

is a component of the matrix of sensitivities

$$S = {( {S}_{i α} )}_{{i = 1 , … , m}_{α = 1 , … , n}} ;$$

wherein fᵢ is a resonance frequency which is a component of the vector of frequencies F=(fᵢ)_{i=1, . . . , m} and x_{α} is one of the 4N characteristics of the object which is a component of the vector of the characteristics to be sought X=(x_{α})_{α=1, . . . , n}. The use of the correlation matrix (degree of similarity) between the vectors of the effects S_{iα} of a parameter x_{α} on the frequency fᵢ allows optimum selection of the parameters which may be determined in a robust way, for example the Young moduli E₃ and E₅ of the particle of FIG. 1. By using the methodology of the experimental schemes, the sensitivities S_{iα} may be computed and an approximate linear function may subsequently be provided which will be used for solving the inverse problem.

It should be noted that for determining the periods of the echoes, the beam 13 of the laser 11 and the second optical wave 25 produced by the laser 21 are applied to the same point of the particle 1. This is not necessarily the case for determining the spectrum of the resonance frequencies of the vibration modes of the particle, the application points of the beam 13 and of the optical wave 25 may be different.

1-16. (canceled)

17. A non-destructive and contactless method for characterizing a multilayered structure with a substantially spherical geometry comprising at least two layers separated by interfaces, the method comprising the following steps:
locally heating the structure with a laser under thermoelastic conditions so that the structure is set into vibration in a non-destructive way;
measuring resonance frequencies of vibration modes of the structure;
inferring at least one characteristic relative to an integrity, or to the geometry or to a mechanical behavior of the structure from the resonance frequencies of the structure.

18. The characterization method according to claim 17 wherein the measuring of the resonance frequencies is carried out with an optical measurement device.

19. The characterization method according to claim 18 wherein the optical measurement device comprises an interferometric device.

20. The characterization method according to claim 17 wherein a presence or absence of cracks in the structure is inferred from the resonance frequencies, a presence of resonance frequencies in at least one predetermined frequency band being characteristic of the presence of a crack in the structure, and the absence of a resonance frequency in the or each predetermined frequency band being characteristic of the absence of cracks in the structure.

21. The characterization method according to claim 17 wherein the inferring includes inferring at least one geometrical or mechanical characteristic of at least one of the layers selected from a density, a thickness, a Young modulus and a Poisson coefficient from the resonance frequencies of the structure.

22. The characterization method according to claim 21 wherein the inferring the at least one geometrical or mechanical characteristic includes performing an inverse method comprising:
a) computing theoretical resonance frequencies from respective sets of theoretical or measured values of the at least one geometrical and mechanical characteristic for the or each layer, including first values of the or each at least one geometrical or mechanical characteristic, the set of theoretical or measured values comprising for the or each layer the density, the thickness, the Young modulus and the Poisson coefficient;
b) computing deviations between the theoretical resonance frequencies and the measured resonance frequencies;
c) selecting a new value for the or each at least one geometrical or mechanical characteristic from the corresponding set of theoretical or measured values; and
iterating the steps a), b) and c) until the deviation computed in step b) is less than a predetermined limit.

23. The characterization method according to claim 22 wherein the theoretical resonance frequencies are computed in step a) with an analytical vibratory model of the structure.

24. The characterization method according to claim 22 wherein the inverse method is initialized by calculating theoretical initial values for the at least one geometrical or mechanical characteristic by inverting a linear vibratory model of the structure, from measured resonance frequencies.

25. The characterization method according to claim 23 wherein in step c), the new values of the or each at least one geometrical or mechanical characteristic are computed by means of a linear vibratory model of the structure, from the first values of the or each at least one geometrical or mechanical characteristic considered in step a) and from the deviations between the theoretical resonance frequencies and the measured resonance frequencies computed in step b).

26. The characterization method according to claim 17 wherein the structure is a nuclear fuel particle comprising a core and at least two layers surrounding the core.

27. The characterization method according to claim 26 wherein the nuclear fuel particle comprises from an interior to an exterior, a fissile material core, a porous pyrocarbon layer, a first dense pyrocarbon layer, a ceramic layer, and a second dense pyrocarbon layer, the at least one geometrical or mechanical characteristic comprising at least two of the characteristics selected from a Young's modulus of the porous pyrocarbon layer, a Young's modulus of the first dense pyrocarbon layer, a Young's modulus of the ceramic layer and a density of the porous pyrocarbon layer.

28. The characterization method according to claim 17 wherein the laser is an intensity-modulated laser.

29. The characterization method according to claim 17 wherein the measuring includes measuring a period of echoes resulting from reflections of elastic waves at interfaces between the layers and the inferring includes inferring at least one characteristic related to the geometry or to the mechanical behavior of the structure from the period.

30. The characterization method according to claim 29 wherein the inferring the at least one characteristic related to the geometry or to the mechanical behavior includes inferring from the period of the echoes a propagation velocity of the elastic waves in one of the layers depending on a thickness of the layer.

31. The characterization method according to claim 30 wherein the inferring the at least one characteristic related to the geometry or to the mechanical behavior includes determining a Young's modulus of the layer according to the propagation velocity and a density of the layer.

32. An installation for characterizing a multilayered structure adapted for applying the method of claims 17, the installation comprising:
a laser capable of locally heating under thermoelastic conditions the structure so that the structure is set into vibration in a non-destructive way;
a device for measuring the resonance frequencies of vibration modes of the structure;
a computer for inferring from the resonance frequencies of the structure the at least one characteristic related to the integrity, or to the geometry or to the mechanical behavior of the structure.

33. The characterization method according to claim 28 wherein the intensity-modulated laser is a pulsed laser delivering an energy comprised between 1 μJ and 1 mJ per pulse, each pulse having a duration comprised between 0.5 and 50 nanoseconds.
